(19) United States
(12) Patent Application Publication
(10) Pub. No.: US 2020/0203093 A1
(43) Pub. Date: Jun. 25, 2020

(54) DIRECT CURRENT ARC EXTINGUISHING APPARATUS

(71) Applicant: Qiaoshi GUO, Guangdong (CN)

(72) Inventor: Qiaoshi Guo, Guangdong (CN)

(21) Appl. No.: 16/633,128

(22) PCT Filed: Jul. 19, 2018
(86) PCT No.: PCT/CN2018/096225

§ 371 Date: Jan. 22, 2020

(30) Foreign Application Priority Data
Jul. 24, 2017 (CN) 201710608043.1
Aug. 10, 2017 (CN) 201710681425.7
Aug. 28, 2017 (CN) 201710752610.0
Sep. 14, 2017 (CN) 201710828462.6
Oct. 20, 2017 (CN) 201710987367.0
Oct. 29, 2017 (CN) 201711028608.5
Nov. 3, 2017 (CN) 201711071590.7
Dec. 6, 2017 (CN) 201711279281.9
Dec. 18, 2017 (CN) 201711360342.4
Dec. 25, 2017 (CN) 201711419656.7
Jan. 11, 2018 (CN) 201810026942.5
Apr. 15, 2018 (CN) 201810334791.X
Apr. 26, 2018 (CN) 201810384250.8
May 27, 2018 (CN) 201810518236.2
Jun. 25, 2018 (CN) 201810664507.5
Jul. 4, 2018 (CN) 201810723029.0
Jul. 18, 2018 (CN) 201810792433.3

(51) Int. Cl. H01H 9/30; H01H 9/54; H02H 1/00; H02H 3/087; H01H 33/04; H02H 3/20

(52) U.S. Cl. CPC H01H 9/30; H01H 9/54; H02H 3/20; H02H 3/087; H01H 33/04; H02H 1/0007

(57) ABSTRACT

The present disclosure relates to a direct current arc extinguishing apparatus suitable for quickly extinguishing arc of mechanical contacts such as mechanical switches, where the mechanical switch requiring to extinguish arc is connected with a load in series. The direct current arc extinguishing apparatus includes a voltage detection switch and a capacitor, the voltage detection switch is connected with the capacitor; during the breaking of the mechanical switch, the capacitor forms a discharge loop by the voltage detection switch and the load, and is used for breaking arc extinguishing of the mechanical switch. The present disclosure is reasonable in design and has the advantages of low cost and high arc extinguishing speed.

### CROSS-REFERENCE TO RELATED APPLICATIONS

This application is a 35 U.S.C. § 371 National Phase filing of International Patent Application No. PCT/CN2018/096225, filed on Jul. 19, 2018, which itself claims the priority to Chinese Patent Application Nos. 201710608043.1, filed on Jul. 24, 2017; 201710681425.7, filed on Aug. 10, 2017; 201710752610.0, filed on Aug. 28, 2017; 201710828462.6, filed on Sep. 14, 2017; 201710987367.0, filed on Oct. 20, 2017; 201711028608.5, filed on Oct. 29, 2017; 201711071590.7, filed on Nov. 3, 2017; 201711279281.9, filed on Dec. 6, 2017; 201711360342.4, filed on Dec. 18, 2017; 201711419656.7, filed on Dec. 25, 2017; 201810026942.5, filed on Jan. 11, 2018; 201810334791.X, filed on Apr. 15, 2018; 201810384250.8, filed on Apr. 26, 2018; 201810518236.2, filed on May 27, 2018; 201810664507.5, filed on Jun. 25, 2018; 201810723029.0, filed on Jul. 4, 2018; and 201810792433.3, filed on Jul. 18, 2018 in the State Intellectual Property Office of P.R. China, which are hereby incorporated herein in their entireties by reference.

### TECHNICAL FIELD

The present invention relates generally to arc extinguishing in the field of electrics, and more specifically, to a direct current arc extinguishing apparatus, which is suitable for quickly extinguishing arc of mechanical contacts such as mechanical switches, as well as extinguishing arc of other breakpoints such as fusing of fuse links, breakpoints between plugs and sockets, and breakpoints of wires.

### BACKGROUND

Currently, mechanical switches such as contactors (relays) are widely used in various direct current electric control systems such as new energy vehicles, rail transit, ships, etc., to on and off the loads. Because direct current has no zero point and its breaking arc is large, it has the shortcomings of high cost of mechanical switches (high voltage contactors) and short electrical life. As the breaking voltage of mechanical switch increases, its electrical life will be greatly reduced. FIG. 1 gives a diagram of a brand of high voltage contactor, which shows that the waveform of the breaking voltage (i.e., arc breaking voltage) is corresponding to its electrical life.

### BRIEF SUMMARY

One of the objectives of the present disclosure is to solve the problem of short electrical life of mechanical switches in the existing direct current electric control systems and to provide a direct current arc extinguishing apparatus with high arc extinguishing effect, reduced breaking voltage (arc breaking voltage) of the mechanical switches and high arc extinguishing speed.

To achieve the objective of the present disclosure, one aspect of the present disclosure presents a direct current arc extinguishing apparatus. The mechanical switch requiring arc extinguishing is connected with a load in series. The apparatus comprises a voltage detection and a capacitor, wherein the voltage detection switch is connected with the capacitor. During the breaking of the mechanical switch, the capacitor forms a discharge loop by the voltage detection switch and the load, which is used for breaking arc extinguishing of the mechanical switch.

In one embodiment, the voltage detection switch is turned on in an interval where the potential difference across the mechanical switch is either greater than 5V and less than or equal to 20V; or greater than 20V and less than the working voltage.

In one embodiment, during the breaking of the mechanical switch, the potential difference between the capacitor and the load is not less than 5V, and the voltage detection switch is turned on.

In one embodiment, the voltage detection switch is turned on when the mechanical switch is arcing.

In one embodiment, during the breaking of the mechanical switch, the voltage detection switch is turned on when the breakdown voltage of the opening distance between the contacts of the mechanical switch is greater than the working voltage of the mechanical switch.

In one embodiment, the voltage detection switch is a semi-controlled switch.

In one embodiment, the voltage detection switch is a two-end circuit.

In one embodiment, the direct current arc extinguishing apparatus further comprises a charging unit for charging the capacitor, and the charging unit is connected in parallel with the voltage detection switch.

In one embodiment, the charging unit comprises a first diode, or comprises a first current limiting element, or comprises a series connection of the first diode and the first current limiting element.

In one embodiment, the direct current arc extinguishing apparatus further comprises a first current limiting element, wherein the capacitor is connected with the power input port of the mechanical switch by the first current limiting element; the voltage detection switch is a three-end circuit; and the detection port of the voltage detection switch is connected with the power input port or the contact bridge of the mechanical switch.

In one embodiment, the semi-controlled switch comprises a thyristor, the gate of which is connected with either the anode or the second anode of the thyristor.

In one embodiment, the direct current arc extinguishing apparatus further comprises a first semiconductor device, wherein the cut-in voltage of the first semiconductor device is greater than 3V and the gate of the thyristor is connected with the anode or the second anode by the first semiconductor device.

In one embodiment, the first semiconductor device is either a Zener diode, a transient voltage suppressor, a trigger diode or a varistor.

In one embodiment, the direct current arc extinguishing apparatus further comprises a second diode, wherein the second diode, the first semiconductor device and the gate of the thyristor are connected in series.

In one embodiment, the detection port of the voltage detection switch is non-insulated and isolated from the output port of the voltage detection switch.

In one embodiment, the voltage detection switch is a delay semiconductor switch.

In one embodiment, the insulating material is used for packaging into a device.

In one embodiment, the direct current arc extinguishing apparatus is packaged as a device with a charging unit for charging the capacitor using insulating material.

In one embodiment, the voltage detection switch comprises a control unit and a power semiconductor device, wherein a voltage signal of the connection node of the mechanical switch and the load is transmitted to the control unit. The power semiconductor device is connected with the control unit. During the breaking of the mechanical switch, the power semiconductor device is turned on, and the capacitor is discharged by the power semiconductor device and the load.

In one embodiment, during the breaking of the mechanical switch, the control unit detects that the contact of the mechanical switch is being broken, and the power semiconductor device is controlled to be turned on by time delay, which is greater than 100 microseconds.

In one embodiment, the control unit performs A/D acquisition on the voltage signal.

In one embodiment, the direct current arc extinguishing apparatus further comprises a charging unit for charging the capacitor. The charging unit is connected in parallel with the power semiconductor device, the connection node of the mechanical switch and the load charges the capacitor by the charging unit, wherein the voltage signal is the voltage of the load.

In one embodiment, the charging unit comprises a first diode and a first current limiting element connected in series, and the voltage signal of the capacitor is transmitted to the control unit for detecting the capacity of the capacitor.

In one embodiment, the voltage signal is either the voltage of the load, or the voltage relative to the other port of the power semiconductor device, or the voltage relative to the power input of the mechanical switch.

In one embodiment, the power semiconductor device is a semi-controlled device.

In one embodiment, a control signal of the mechanical switch is transmitted to either the control unit, or a control signal of the control unit is transmitted to the mechanical switch.

In one embodiment, the control unit stores an adaptive control program, and optimizes arc extinguishing control parameter by utilizing changes of the voltage signal or the voltage signal of the power semiconductor device relative to the other port connected with the load.

In one embodiment, the direct current arc extinguishing apparatus further comprises a charging unit for charging the capacitor, wherein the charging unit at least comprises a charging switch, and a control signal of the control unit is transmitted to the charging switch.

In one embodiment, the main loop power supply of the mechanical switch charges the capacitor by the charging switch.

In one embodiment, the charging switch is either a first semiconductor switch, or a fourth mechanical switch, or comprises the fourth mechanical switch and the first semiconductor switch connected in series, where the first semiconductor switch is a semi-controlled device.

In one embodiment, the direct current arc extinguishing apparatus further comprises a first current limiting element, and the charging switch is connected in series with the first current limiting element.

In one embodiment, when the closing operation of the mechanical switch is as follows: the control unit firstly controls the charging switch, then the power semiconductor device is turned on, and finally the mechanical switch is closed. During the breaking operation of the mechanical switch, the charging switch is in a cut-off state.

In one embodiment, the direct current arc extinguishing apparatus further comprises a fourth semiconductor switch, wherein the fourth semiconductor switch is a semi-controlled device. The control port of the fourth semiconductor switch is connected with the control unit. The second series circuit comprises the capacitor and the fourth semiconductor switch. The capacitor forms a discharge loop by the fourth semiconductor switch, the power semiconductor device and the load.

In one embodiment, the direct current arc extinguishing apparatus further comprises a third diode, and the main loop power supply of the mechanical switch charges the capacitor by the charging switch and the third diode.

In one embodiment, the direct current arc extinguishing apparatus further comprises a fifth semiconductor device, wherein the input power supply end of the mechanical switch is connected with a battery, and the battery is connected with a charging mechanical switch. During the breaking of the charging mechanical switch, the capacitor is discharged by the fifth semiconductor device, the fourth semiconductor switch and the battery for breaking and extinguishing arc of the charging mechanical switch. The fifth semiconductor device is either a fifth diode or a fifth unidirectional thyristor connected with the control unit.

In one embodiment, the charging switch and the power semiconductor device are both semi-controlled switches. A voltage signal of common node of the second series circuit, the charging switch and the power semiconductor device are connected to the control unit.

In one embodiment, it is used for detecting the working state of the power semiconductor device.

In one embodiment, it is used for detecting the capacity of the capacitor. The capacitor is connected in series with a first current limiting element, and the first current limiting element is a resistor.

In one embodiment, it is used for detecting the working state of the charging switch.

In one embodiment, it is used for detecting the working state of the fourth semiconductor switch.

In one embodiment, either the control signal of the mechanical switch is transmitted to the control unit, or the control signal of the control unit is transmitted to the mechanical switch.

In one embodiment, the control unit controls the power semiconductor device to be turned on when the control unit detects arcing in the off state of the mechanical switch.

In one embodiment, the direct current arc extinguishing apparatus further comprises a fifth unidirectional thyristor, which is connected with the control unit. The input power supply end of the mechanical switch is connected with a battery. The battery is connected with a charging mechanical switch. During the breaking of the charging mechanical switch, the capacitor is discharged by the fifth unidirectional thyristor and the battery, which is used for breaking and extinguishing arc of the charging mechanical switch.

In one embodiment, the number of mechanical switch is at least two, namely a first mechanical switch and a second mechanical switch; the number of the load is at least two, namely a first load and a second load; the number of the power semiconductor device is at least two, namely a first power semiconductor device and a second power semiconductor device.

In one embodiment, the number of mechanical switch is three; the number of the load is three; and the number of the power semiconductor device is three.

In one embodiment, the first load and the second load are the loads of the first mechanical switch.

In one embodiment, the charging switch comprises a fourth mechanical switch. The charging switch is also connected in series with a first current limiting element, and a control signal of the control unit is connected to a control port of the fourth mechanical switch.

In one embodiment, during the breaking of the mechanical switch is as follows: The control unit detects that the contact of the mechanical switch is being broken, and controls the power semiconductor device to be turned on with delay, which is greater than 100 microseconds; and then, the control unit stores parameter related to the current of the load or receives parameter related to the current of the load. During the breaking of the mechanical switch, the larger the current of the load, the longer the delay time.

In one embodiment, the control unit either stores or receives the parameter related to the current of the load. The larger the current of the load, during the breaking operation of the mechanical switch, the larger the voltage difference between the capacitor and the load, and finally, the power semiconductor device is turned on.

In one embodiment, the control unit stores an adaptive control program, and optimizes arc extinguishing control parameter by utilizing changes of the voltage signal or the voltage signal of the power semiconductor device relative to the other end connected with the load.

The working principle for the breaking of the mechanical switch is as follows: The capacitor forms a discharge loop by the voltage detection switch and the load; then, the voltage across the load rises; and the electric field strength between contacts of the mechanical switch rapidly decreases, so as to achieve the purpose of quickly extinguishing arc of the mechanical switch (i.e., achieving the purpose of breaking without arc or breaking with extremely short arcing time).

The present disclosure is reasonable in design and has the advantages of high arc extinguishing effect, reduced breaking voltage of mechanical switch and high arc extinguishing speed.

### BRIEF DESCRIPTION OF DRAWINGS

FIG. 1 is a diagram showing the relationship between a waveform of breaking voltage and the electrical life of a brand of high voltage contactor.

FIG. 2 is a schematic diagram of a circuit of Embodiment 1 of a direct current arc extinguishing apparatus according to the present disclosure.

FIG. 3 is a schematic diagram of a circuit of Embodiment 2 of a direct current arc extinguishing apparatus according to the present disclosure.

FIG. 4 is a schematic diagram of a circuit of Embodiment 3 of a direct current arc extinguishing apparatus according to the present disclosure.

FIG. 5 is a schematic diagram of a circuit of Embodiment 4 of a direct current arc extinguishing apparatus according to the present disclosure.

FIG. 6 is a diagram of a delay circuit of voltage detection switch of a direct current arc extinguishing apparatus according to the present disclosure.

FIG. 7 is schematic diagram 1 of a package of a direct current arc extinguishing apparatus according to the present disclosure.

FIG. 8 is schematic diagram 2 of a package of a direct current arc extinguishing apparatus according to the present disclosure.

FIG. 9 is a schematic diagram of a circuit of Embodiment 5 of a direct current arc extinguishing apparatus according to the present disclosure.

FIG. 10 is a schematic diagram of a circuit of Embodiment 6 of a direct current arc extinguishing apparatus according to the present disclosure.

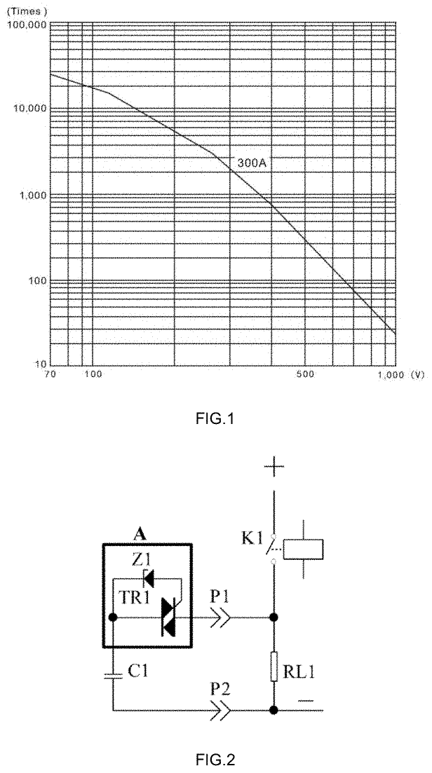

### DETAILED DESCRIPTION

[Embodiment 1 of a direct current arc extinguishing apparatus of the present disclosure is shown in FIG. 2, where a mechanical switch K1 requiring the arc extinguishing is connected in series with a load RL1, and comprises a voltage detection switch A and a capacitor C1. The voltage detection switch A is connected with the capacitor C1. In the breaking of the mechanical switch K1, the capacitor C1 forms a discharge loop by the voltage detection switch K1 and the load RL1, and is used to extinguish arc when mechanical switch K1 is being broken.

Voltage detection switch A: It is used for detecting the potential difference between the capacitor C1 and the load RL1. It comprises a thyristor TR1 (bidirectional thyristor) and a first semiconductor device Z1 (Zener diode), and a gate of the thyristor TR1 is connected with a second anode of the thyristor TR1 by the first semiconductor device Z1.

Working principle: The mechanical switch K1 is closed, and then the voltage detection switch A is triggered to conduct and charge the capacitor C1. In the breaking of the mechanical switch K1, when the potential difference between the capacitor C1 end and the load RL1 is larger than the cut-in voltage of the voltage detection switch A (the potential difference is approximately equal to the potential difference between the two ends of the mechanical switch K1, and the cut-in voltage is determined by the first semiconductor device Z1); the thyristor TR1 is triggered to conduct; the capacitor C1 is discharged rapidly by the thyristor TR1 and the load RL1; the voltage across the load RL1 rises; the electric field strength between the contacts of the mechanical switch K1 rapidly decreases; and finally the purpose of quickly extinguishing the arc of the mechanical switch K1 is achieved.

In this embodiment, the voltage detection switch A adopts a bidirectional thyristor, which can be used for charging and discharging at the same time, and which has the advantages of simple circuit and low cost.

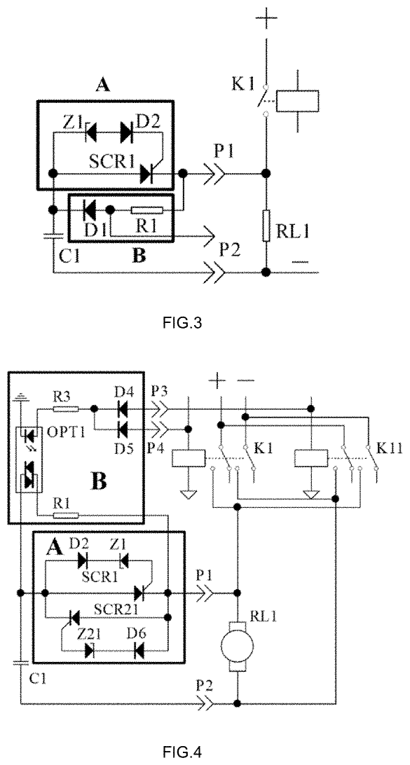

Embodiment 2 of a direct current arc extinguishing apparatus of the present disclosure is shown in FIG. 3, where the direct current arc extinguishing apparatus, comprising a voltage detection switch A, a capacitor C1 and a charging unit B. Here, the charging unit B is connected with the voltage detection switch A in parallel.

Voltage detection switch A: It is used for detecting the potential difference between the capacitor C1 and the load RL1. It comprises a thyristor SCR1 (unidirectional thyristor), a first semiconductor device Z1 (Zener diode) and a second diode D2. The gate of the thyristor SCR1 is connected with the anode of the thyristor SCR1 by the second diode D2 (for preventing the influence of reverse voltage on the circuit) and a first semiconductor device Z1.

Charging unit B: It normally comprises a first diode D1 and a first current limiting element R1 (resistor) in series. In some real-life situations, it may only comprise either the first current limiting element R1 alone or the first diode D1.

Working principle: The mechanical switch K1 is closed, and then the main loop power supply of the mechanical switch K1 charges the capacitor C1 by the charging unit B. In the breaking of the mechanical switch K1, when the potential difference between the capacitor C1 end and the load RL1 is larger than the cut-in voltage of the voltage detection switch A, the thyristor SCR1 triggers conduction; the capacitor C1 is discharged rapidly by the thyristor SCR1 and the load RL1; the voltage across the load RL1 rises; the electric field strength between contacts of the mechanical switch K1 rapidly decreases; and finally the purpose of quickly extinguishing the arc of the mechanical switch K1 is achieved.

In this embodiment, the voltage detection switch A adopts a unidirectional thyristor, which has the advantages of high current rise rate tolerance and good reliability. At the same time, it adopts a charging unit B, which has the advantage of small current impact when the mechanical switch K1 is closed.

In the foregoing two embodiments, the voltage detection switch A is a two-end circuit and a semi-controlled switch, which is composed of a semiconductor device and has the advantages of simple circuit and low cost. The charging power supply of capacitor C1 is provided by the connection node of mechanical switch K1 and load RL1, which has the advantages of not affecting the isolation voltage across mechanical switch K1 and no leakage current when mechanical switch K1 is normally open.

Embodiment 3 of a direct current arc extinguishing apparatus of the present disclosure is shown in FIG. 4. When it is necessary to control the forward and reverse arc extinguishing of the direct circuit motor, it is required to increase the number of relevant components and the enabling terminals appropriately. A working principle is the same as the forgoing embodiments, so it will not be repeated here.

Embodiment 4 of a direct current arc extinguishing apparatus of the present disclosure is shown in FIG. 5, where the direct current arc extinguishing apparatus comprises a voltage detection switch A, a capacitor C1 and a first current limiting element R1 (a resistor and a charging unit B). Here, the capacitor C1 is connected with a power input port of a mechanical switch K1 by the first current limiting element R1, and the detection port of the voltage detection switch A is connected with the power input port of the mechanical switch K1 (it can be a contact bridge of the mechanical switch K1 when the mechanical switch K1 is in a bridge structure, and the second capacitor C2 can be optional according to requirements).

Voltage detection switch A: It is a three-end circuit and a semi-controlled switch. It adopts a capacitive coupling input signal and consists of thyristor TR1 (bidirectional thyristor or unidirectional thyristor), first semiconductor device Z1 (a Zener diode) and second capacitor C2. It is used to detect the potential difference between the two ends of mechanical switch K1 (or between contact bridge and static contact when it's the bridge structure, i.e., double breakpoint structure).

Working principle: When the power input port of the mechanical switch K1 is powered on, the direct current power supply charges the capacitor C1 by the first current limiting element R1; the mechanical switch K1 is closed; the capacitor C2 forms a discharge loop by the first semiconductor device Z1 and the mechanical switch K1. When the mechanical switch K1 bounces, the thyristor TR1 triggers conduction, and the capacitor C1 is discharged by the thyristor TR1 and the load RL1 to achieve the purpose of closing, bouncing and extinguishing the arc of the mechanical switch K1. In the breaking of the mechanical switch K1, when the potential difference across the mechanical switch K1 is greater than the cut-in voltage of the voltage detection switch A, the thyristor TR1 triggers conduction; the capacitor C1 is discharged rapidly by the thyristor TR1 and the load RL1; the voltage across the load RL1 rises; the electric field strength between the contacts of the mechanical switch K1 rapidly decreases; and finally the purpose of quickly extinguishing the arc of the mechanical switch K1 is achieved.

In Embodiment 4, the capacitor C1 may be an electrolytic capacitor. The capacitor C1 is connected to the power input port of the mechanical switch K1 by the first current limiting element R1. The detection port of the voltage detection switch A is connected to the power input port (or contact bridge) of the mechanical switch K1, which can extinguish arc for closing and bouncing of the mechanical switch K1. At the same time, after the capacitor C1 is fully charged, it has the advantage of no power consumption.

In the foregoing embodiments 1, 2, 3 and 4, the cut-in voltage of the first semiconductor device Z1 has to be greater than 3V (to be greater than the peak-to-peak value of the system ripple voltage), and equivalent device such as transient voltage suppressor, trigger diode, or varistor can be used. When the cut-in voltage of the thyristor is greater than 5V, the first semiconductor device Z1 is selected according to the needs of the operating conditions.

In the breaking of the mechanical switch K1, the gate of the thyristor does not need series resistor to limit current, so that the triggering speed of the thyristor can be improved, the loss of the charge of the capacitor before the thyristor being turned on can be reduced, and the capacity utilization rate of the capacitor can be improved. In the foregoing embodiments, the voltage detection switch A is in non-insulated isolation, and the charging power supply of the capacitor is provided by the non-electrical isolation (current limiting) of the main loop power supply of the mechanical switch, thus having the advantage of low cost.

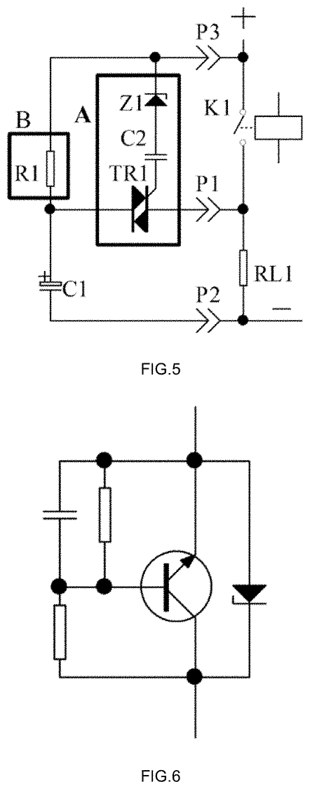

In practical application, a delay circuit as shown in FIG. 6 or similar circuit can also be used for the first semiconductor device Z1 of the voltage detection switch A. Here, the voltage detection switch A is a delay on switch, which can ensure that the mechanical switch K1 has sufficient opening distance for arc extinguishing to prevent reignition when arc extinguished. The delay on time of the switch is preferably controlled to be greater than 100 microseconds.

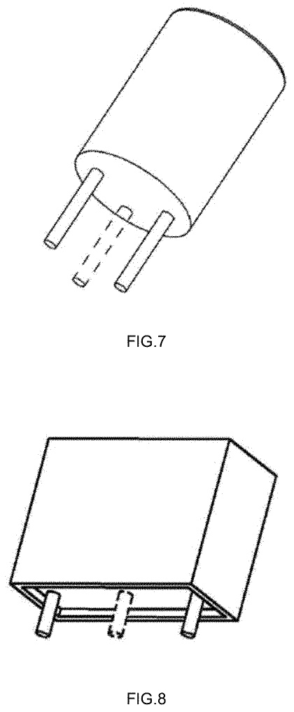

In order to facilitate popularization, standardization, batch production, and generalization, the foregoing embodiments can be packaged into a device using insulating materials, and can be in the form of two ports or three ports. The charging unit (or the first current limiting element) can be externally arranged according to the situation (three ports when externally arranged, with one port being an end point where a capacitor is connected with a power semiconductor device); it can also be built-in, adopting either a circular structure (shown in FIG. 7) or a square structure (shown in FIG. 8).

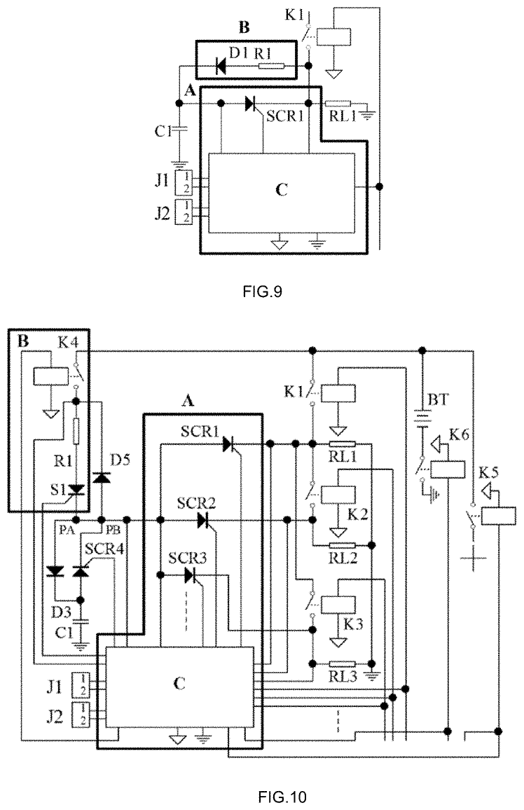

Embodiment 5 of a direct current arc extinguishing apparatus of the present disclosure is shown in FIG. 9, where the direct current arc extinguishing apparatus comprises a voltage detection switch A, a capacitor C1 and a charging unit B.

Voltage detection switch A: It comprises a control unit C and a power semiconductor device SCR1 (a semi-controlled device and a unidirectional thyristor). The voltage signal of the connection node of the mechanical switch K1 and the load RL1 is transmitted to the control unit C. The power semiconductor device SCR1 is connected with the control unit C. During the breaking of the mechanical switch K1, the power semiconductor device SCR1 is turned on; the capacitor C1 is discharged by the power semiconductor device SCR1 and the load RL1. Here, the J1 port is the control power supply port; J2 port is a communication port, which is used to receive control instructions and data, and to transmit the device and external status information (mechanical switch, load status, etc.). J1 and J2 are optional as required.

Control unit C: The built-in programmable device (microcontroller) can use A/D to collect the voltage of load RL1. The voltage signal of capacitor C1 is transmitted to control unit C for detecting the capacitance of capacitor C1. A control signal of the mechanical switch K1 is transmitted to control unit C (selected as required), or the control mode provided by control unit C (selected as required) with the control signal of the mechanical switch K1 can be adopted. It either stores or receives parameter related to the current of the load RL1. During the breaking operation of the mechanical switch K1, it is detected that the contact of the mechanical switch K1 is being broken, and the power semiconductor SCR1 is controlled to be turned on by time delay. The larger the current of the load RL1, the longer the delay time, and the delay time is proportional to the current of the load RL1. During the breaking operation of the mechanical switch K1, the larger the current of the load RL1 is, the larger the voltage difference between the capacitor C1 and the load RL1 is, until the power semiconductor device SCR1 is turned on, which is used for improving the discharge current of the capacitor C1 and improving the arc extinguishing effect.

Charging unit B: It is connected in parallel with power semiconductor device SCR1, where the connection node of mechanical switch K1 and load RL1 charges capacitor C1 by charging unit B. It is composed of either both a first diode D1 and a first current limiting element R1 in series, or the first diode D1 alone, or the first current limiting element R1. When the power semiconductor device SCR1 adopts a bidirectional thyristor, the charging unit B can be selected as required.

Working principle: The mechanical switch K1 is closed, the main loop power supply of the mechanical switch K1 charges the capacitor C1 by the charging unit B, and the control unit C detects the capacitance of the capacitor C1 according to the charging speed of the capacitor C1 (used for judging whether the capacitance of the capacitor is normal or not and optimizing the arc extinguishing control program according to the collected voltage signal data). During the breaking of the mechanical switch K1, the control unit C detects that the contact of the mechanical switch K1 is being broken, and delays the conduction of the power semiconductor device SCR1 (the delay is more than 100 microseconds, or measures to the voltage value set by the control unit C, and the delay time value is related to the breaking speed of the mechanical switch K1). Alternatively, when it is detected that the voltage signal of the connection node of the mechanical switch K1 and the load RL1 reaches a preset voltage value (or simultaneously accords with the time value set by the control unit C, which is related to the breaking speed of the mechanical switch K1), the power semiconductor device SCR1 is controlled to be conductive. The capacitor C1 is discharged rapidly by the power semiconductor device SCR1 and the load RL1; the voltage across the load RL1 rapidly rises; the electric field strength between the contacts of the mechanical switch K1 rapidly decreases; and finally the purpose of rapidly extinguishing arc of the mechanical switch K1 is achieved.

In Embodiment 5, the voltage signal of the connection node of the mechanical switch K1 and the load RL1 may be either a voltage signal across the load RL1, or a potential difference between the capacitor C1 and the load RL1 (i.e., a potential difference between both ends of the power semiconductor device SCR1). The voltage detection switch A adopts a unidirectional thyristor, which has the advantages of high current rise rate tolerance and high reliability. Meanwhile, the charging unit B is adopted, which has the advantage of small impact on the closing current of the mechanical switch K1. The charging power supply of capacitor C1 is provided by the connection node of mechanical switch K1 and load RL1, which has the advantages of not affecting the isolation voltage across mechanical switch K1 and no leakage current in the normally open state of mechanical switch K1. The control unit C stores an adaptive control program. In the breaking of the mechanical switch K1, either the change of the voltage signal of the connection node of the mechanical switch K1 and the load RL1, or the voltage signal of the other end of the connection node of the power semiconductor device SCR1 and the load RL1 (i.e., the connection node of the capacitor C1 and the power semiconductor device SCR1) is utilized to optimize the arc extinguishing control parameter (i.e., adjust the time difference between controlling the conduction of the power semiconductor device and the disconnection of the contact of the mechanical switch) to achieve the best arc extinguishing effect. The control unit C comprises a programmable device, which has a built-in intelligent unit used for program controlling, which can complete timing, A/D acquisition, voltage comparison, logic processing and which is good for simplifying the circuit. It can adjust the control mode according to different conditions (voltage changes) of the load, improve the arc extinguishing effect, and effectively prolong the electrical life of the mechanical switch. The electrical life of the mechanical switch is calculated according to the arcing condition and the operation times. The contact state (on state, off state, arcing state) of the mechanical switch K1 can be detected in real time without auxiliary contacts, and relevant information is transmitted.

Embodiment 6 of a direct current arc extinguishing apparatus of the present disclosure is shown in FIG. 10, which, also called a direct current arc management system, is suitable for multiplex mechanical switches electric control systems such as new energy vehicles. It comprises a voltage detection switch A, a capacitor C1, a charging unit B, a third diode D3 and a fourth semiconductor switch SCR4 (the semi-controlled device, unidirectional thyristor, PA and PB can be disconnected as required, but is not recommended; when PA and PB are disconnected, a control unit C needs to collect the voltages of PA and PB). The third diode D3 is connected in parallel with the fourth semiconductor switch SCR4, and the control port of the fourth semiconductor switch SCR4 is connected with the control unit C. A voltage signal of a common end PB in a second series circuit, which comprises the capacitor C1, the fourth semiconductor switch SCR4, a first semiconductor switch S1 (semi-controlled device, unidirectional thyristor, charging switch) of the charging unit B, and a power semiconductor device (SCR1, SCR2, SCR3, semi-controlled device, unidirectional thyristor), is connected to the control unit C. The input power supply end of the mechanical switch K1 (main positive contactor) is connected with a battery BT, which is connected with a charging mechanical switch K5, and the negative electrode of which is connected with the working ground by a sixth mechanical switch K6 (main negative contactor). Further included is a fifth semiconductor device D5 (a fifth diode; which can also be replaced by a fifth unidirectional thyristor connected to the control unit C. When the fifth unidirectional thyristor is used, the fourth semiconductor switch SCR4 is selected as required. During the breaking of the charging mechanical switch K5, the capacitor C1 is discharged by the fifth unidirectional thyristor and the battery BT for arc extinguishing while the charging mechanical switch K5 is being broken.) The J1 port is the control power supply port; and J2 port is a communication port, which is used to receive control instructions and data, and to transmit the device and external status information (mechanical switch, load status, etc.). J1 and J2 are selected as required.

Voltage detection switch A: It comprises a control unit C and power semiconductor device (SCR1, SCR2, SCR3), the voltage signal of connection node of mechanical switch (K1, K2, K3, K5) and load (RL1, RL2, RL3, BT) is transmitted to the control unit C; and the power semiconductor device (SCR1, SCR2, SCR3) is connected to the control unit C.

Control unit C: It is a built-in programmable device (microcontroller) for A/D acquisition of voltage signal of load (RL1, RL2, RL3) and common end PB, and the voltage signal of the input power supply end of the mechanical switch K1 is connected to the control unit C (A/D acquisition). During the breaking operation of the mechanical switch (K1, K2, K3), it is detected that the contact of the mechanical switch (K1, K2, K3) is being broken, and the delay controls the conduction of power semiconductor device (SCR1, SCR2, SCR3). The electrical characteristics of the mechanical switch (K1, K2, K3) and the load (RL1, RL2, RL3) connected to the control unit C are not necessarily coincident; thus, in order to achieve the best arc extinguishing effect, the control unit C needs to either store or receive the parameter related to the current of the load (RL1, RL2, RL3), or the operation time parameter of the mechanical switch (K1, K2, K3,). During the breaking operation of the mechanical switch (K1, K2, K3), the larger the current of the load (RL1, RL2, RL3), the longer the delay time, and the delay time is proportional to the current of the load (RL1, RL2, RL3). The time parameter of the delay control can be completed by a microcontroller built in the control unit C. The control signal of the mechanical switch (K1, K2, K3, K5, K6) is transmitted to the control unit C (which is beneficial to improving arc extinguishing accuracy and real-time performance, and can be selected according to needs). The control mode, in which the control signal of the mechanical switch (K1, K2, K3, K5, K6) is provided by the control unit C, can also be adopted (which is more beneficial to optimizing and controlling the action logic and arc extinguishing control logic of each mechanical switch, and can be selected according to needs).

During the breaking operation of the mechanical switch (K1, K2, K3), the larger the current of the load (RL1, RL2, RL3) is, the larger the voltage difference between the capacitor C1 and the load (RL1, RL2, RL3) is, and the power semiconductor device (SCR1, SCR2, SCR3) is turned on, which is used for improving the discharge current of the capacitor C1.

Charging unit B: It comprises a fourth mechanical switch K4, a first current limiting element R1 (a resistor, which can be omitted when the third diode D3 is connected in series with the current limiting element and the load is a non-capacitive load), and a first semiconductor switch S1 (semi-controlled device, unidirectional thyristor). The fourth mechanical switch K4 and the first semiconductor switch S1 are charging switches. The control signal of the control unit C is transmitted to the fourth mechanical switch K4 and the first semiconductor switch S1. The fourth mechanical switch K4 is used in series with the first semiconductor switch S1; the first semiconductor switch S1 is used for overcoming the closed arc of the fourth mechanical switch K4; and the fourth mechanical switch K4 is used for improving the safety of the system. In practical engineering applications, the fourth mechanical switch K4 and the first semiconductor switch S1 can be optional. The main circuit power supply of the mechanical switch K1 (the main circuit power supply end of the mechanical switch K1) charges the capacitor C1 by the fourth mechanical switch K4, the first current limiting element R1, the first semiconductor switch S1 and the third diode D3 (it is optional when the fourth semiconductor switch SCR4 adopts a bidirectional thyristor).

Working principle: The mechanical switch K6 is closed, when the power input of the mechanical switch K1 is powered on (the battery BT is turned on); the control unit C first controls the fourth mechanical switch K4 to be closed; and then the control unit C provides a pulse signal to trigger the first semiconductor switch S1 to charge the capacitor C1. When the charging current is less than the minimum on-hold current of the first semiconductor switch S1, the first semiconductor switch S1 turns off on its own. when charging of the capacitor C1, by detecting the voltage of the common end PB point, the control unit C can check whether the first semiconductor switch S1 is in an on or off state, judge whether the charging of the capacitor C1 is completed, and can detect the capacitance of the capacitor C1 (used for judging whether the capacitance of the capacitor is normal, and optimizing the arc extinguishing control program corresponding to the collected voltage signal data). During the closing operation of the mechanical switch (K1, K2, K3), the control unit C provides a pulse signal to trigger the first semiconductor switch S1 and the power semiconductor device (any one of SCR1, SCR2, SCR3) to conduct and supply power to the load (any one of RL1, RL2, RL3) (such as the motor controller, direct current converter, etc.), which can effectively overcome the current impact of capacitive load on the mechanical switch (K1, K2, K3) and closing arc. The control unit C can decide whether the first semiconductor switch S1 and the power semiconductor device (SCR1, SCR2, SCR3) is turned off or not by detecting the voltage of the common end PB point, and if turned off, the mechanical switch (K1, K2, K3) is also closed.

During the breaking of the mechanical switch (K1, K2, K3), the first semiconductor switch S1 is in an off state. The control unit C detects that the contacts of the mechanical switch (K1, K2, K3) is disconnected, and then controls the fourth semiconductor switch SCR4 and the power semiconductor device (SCR1, SCR2, SCR3) to be turned on in delay (the delay is more than 100 microseconds, which can be completed by the built-in microcontroller, or conforms to the voltage value set by the control unit C at the same time, and the delay value is related to the breaking speed of the corresponding mechanical switch). Alternatively, when it is detected that the voltage signal of the connection node of the mechanical switch (K1, K2, K3) and the load (RL1, RL2, RL3) reach a preset voltage value (or conforms to the time value set by the control unit C at the same time, which is related to the breaking speed of the corresponding mechanical switch), the fourth semiconductor switch SCR4 and the power semiconductor device (SCR1, SCR2, SCR3) is controlled to be conductive. The control unit C can decide whether the fourth semiconductor switch SCR4 and the power semiconductor device (SCR1, SCR2, SCR3) is in an on state by detecting the voltage of the common end PB point. The capacitor C1 is discharged rapidly by the load (RL1, RL2, RL3), the fourth semiconductor switch SCR4 and the power semiconductor device (SCR1, SCR2, SCR3); the voltage across the load (RL1, RL2, RL3) rises; the electric field strength between contacts of the mechanical switch (K1, K2, K3) rapidly decreases; and finally the purpose of rapidly extinguishing arc of the mechanical switch (K1, K2, K3) is achieved. The control unit C decides whether the fourth semiconductor switch SCR4 and the power semiconductor device (SCR1, SCR2, SCR3) is in the off state by detecting the voltage of the common end PB, so as to judge whether the capacitor C1 has completed discharging and prepare for the next charging of the capacitor C1.

During the breaking of the charging mechanical switch K5, the control unit C controls the fourth semiconductor switch SCR4 to turn on, and the capacitor C1 is discharged by the fourth semiconductor switch SCR4 and the battery BT, the fifth semiconductor device D5 and the fourth mechanical switch K4, thus extinguishing the arc of the charging mechanical switch K5 while breaking.

The control unit C performs A/D acquisition (or high and low level acquisition) on the voltage signal of the common end PB, and has the following advantages:

1. The fourth semiconductor switch SCR4, the fifth semiconductor device D5, the first semiconductor switch S1, and the power semiconductor device (SCR1, SCR2, SCR3) can be quickly and accurately detected in either an on state, or an off state (whether charging or discharging is completed), or a breakdown state by using a single endpoint without high-resolution A/D acquisition, thereby ensuring the response speed and safety of the system.

2. The capacitance of the capacitor C1 is detected under the condition that the electric energy of the capacitor C1 is not consumed; the capacitor C1 does not need to be frequently charged; the voltage across the capacitor C1 is indirectly known; and the response speed and safety of the system are improved.

The load (RL1, RL2, RL3) may be of different types such as motor controllers, DC/DC converters, motors, resistors, etc.

The foregoing voltage signal of the connection node of the mechanical switch (K1, K2, K3) and the load (RL1, RL2, RL3) are the voltage of the two ends of the load (RL1, RL2, RL3) (when the control unit C is used for A/D acquisition of the voltage signal, it has the advantages of not affecting the insulation withstand voltage of the two ends of the mechanical switch K1, and no leakage current when the mechanical switch K1 is normally open). The voltage signal may also be a potential difference between the capacitor C1 and the load (RL1, RL2, RL3), that is, a voltage relative to either the other end of the power semiconductor device (SCR1, SCR2, SCR3), or the power input end of the mechanical switch (K1, K2, K3).

In the breaking of the mechanical switch, when the change speed of the voltage signal is less than the change speed set by the control unit C, the control unit C does not provide the relevant power semiconductor device conduction control signal to prevent the capacitor C1 from discharging too slowly, the power semiconductor device (SCR1, SCR2, SCR3) from turning off too slowly and thus affecting the arc extinguishing response speed of other mechanical switches. The control unit C stores the parameter related to the residual voltage change of the load, which is beneficial to improving the accuracy of the breaking detection of the mechanical switch. The control unit C stores an adaptive control program. During the breaking of the mechanical switch (K1, K2, K3), the change of the voltage signal of the connection node of the mechanical switch (K1, K2, K3, K5) and the load (RL1, RL2, RL3) or the voltage signal of the other end (PB) of the connection node of the power semiconductor device (SCR1, SCR2, SCR3) and the load (RL1, RL2, RL3) is utilized to optimize the arc extinguishing control parameter(s) (i.e., to adjust the time difference between the conduction of the power semiconductor device and the disconnection of the contacts of the mechanical switch) so as to achieve the optimal arc extinguishing effect.

The mechanical switch K1, the mechanical switch K2 and the mechanical switch K3 are respectively defined as a first mechanical switch, a second mechanical switch and a third mechanical switch;

The load RL1, the load RL2 and the load RL3 are respectively defined as a first load, a second load, and a third load;

The power semiconductor device SCR1, the power semiconductor device SCR2, and the power semiconductor device SCR3 are respectively defined as a first power semiconductor device, a second power semiconductor device, and a third power semiconductor device.

In this embodiment, the second load and the third load are both the loads of the first mechanical switch (mechanical switch K1).

When used in the occasions of arc extinguishing of multiplex mechanical switches such as new energy vehicles, the fourth mechanical switch K4 is a pre-charge contactor, the first current limiting element R1 is a pre-charge resistor, the first mechanical switch (mechanical switch K1) is a main positive contactor, and the sixth mechanical switch K6 is a main negative contactor. When arc extinguishing fails, the sixth mechanical switch K6 is controlled to break. The control unit C controls the fourth mechanical switch K4 to be turned off when detecting abnormality (such as breakdown or spurious triggering of the first semiconductor switch, breakdown or spurious triggering of the power semiconductor device). Except for the sixth mechanical switch K6 and the fourth mechanical switch K4, the other mechanical switch (K1, K2, K3, K5) of the direct current arc extinguishing apparatus of this disclosure can adopt common (non-sealed high-voltage) contactor, which can greatly reduce the cost and improve the safety (no risk of air leakage). Especially when it is applied to the working conditions where automobiles and similar appliances are in motion and unexpected mechanical impacts (such as collision, rollover, etc.) may occur, mechanical switch (K1, K2, K3) may accidentally close and break in a normally open state, or the opening distance may become smaller, or impact voltages may occur across mechanical switch (K1, K2, K3), and arcing may occur at this time. When the control unit C detects arcing under the breaking state of the mechanical switch (K1, K2, K3), the control unit C controls conduction of power semiconductor device (SCR1, SCR2, SCR3), and the capacitor C1 forms a discharge loop by the power semiconductor device (SCR1, SCR2, SCR3) and the load (RL1, RL2, RL3) to extinguish arc. When the control unit C detects the failure of arc extinguishing, it outputs a signal to control the mechanical switch K6 to break.

In this embodiment, the control unit C comprises a programmable device, which has a built-in intelligent unit used for program controlling. It can adjust the control mode according to different conditions of the load (RL1, RL2, RL3), improve the arc extinguishing effect, and effectively prolong the electrical life of the mechanical switch. Timing (delay control power semiconductor device), A/D acquisition, voltage comparison, logic processing, etc. can also be completed, which is beneficial to simplifying the circuit. A capacitor, a control unit and a charging switch are jointly used for arc extinguishing control, pre-charging (or closing arc extinguishing) and detection (on state, off state and arcing state) of a multiplex mechanical switches (the mechanical switches can be connected in series with each other). The electrical life of the mechanical switch is calculated according to the arcing conditions and the operation times, and relevant information (fault codes, etc.) is transmitted. As a direct current arc extinguishing apparatus (direct current arc management system) with arc management and arc extinguishing functions, it is conducive to improving the overall safety of the electric control systems and has the characteristics of higher cost performance, and can be widely applied to new energy vehicles, rail transit, ships, aviation, automatic control and other fields.

According to real-life working condition, the capacitor C1 and the fourth semiconductor switch can also be multiple, which can improve the response speed; and can adopt a multi-pulse arc extinguishing mode (two or more capacitors, arc of the mechanical switch is extinguished by two or more pulses), and the charging unit B can also adopt a switching power supply to charge the capacitor C1.

In the embodiments 5 and 6, it is suggested that the control unit C should use a transformer to trigger a power semiconductor device. The control unit C stores an adaptive control program. The control unit C adjusts the time difference between the conduction of the power semiconductor device and the disconnection of the contact of the mechanical switch by using the voltage change rate of the voltage signal of the connection node of the mechanical switch and the load in the breaking of the mechanical switch. A small rate of change means a large breaking current, and the time difference needs to be increased, so that the contacts of the mechanical switch have a relatively large opening distance, and the arc breaking capability of the mechanical switch is relatively strong. Combined with capacitor is discharged to extinguish the arc, the purpose of stable and reliable arc extinguishing can be achieved.

In the foregoing embodiments, the electrical parameter of the voltage detection switch can be selected with reference to the following requirements:

1. When the working voltage of the mechanical switch is not high (less than or equal to 200V), or when the capacitance of capacitor is large, the voltage detection switch can be designed to conduct in an interval where the potential difference across the mechanical switch is greater than 5V and less than or equal to 20V (when the capacitance of capacitor is large enough, the voltage value can be appropriately lowered).

2. When the working voltage of the mechanical switch is high (greater than 200V), or the capacitance of capacitor is small, or the internal resistance of the discharge circuit is high, the voltage detection switch (power semiconductor device) can be designed to conduct when the voltage across the mechanical switch is greater than 20V and less than the working voltage interval of the mechanical switch in the breaking of the mechanical switch; and preferably less than ½ of the working voltage of the mechanical switch. This is because during the breaking of the mechanical switch, the voltage across the mechanical switch rises at a high rate between 0 and 20V, and the distance between the contacts of the mechanical switch is small. At the same time, in the breaking of the mechanical switch, the potential difference between the capacitor and the load is not less than 5V, and the voltage detection switch is turned on. It is used to obtain larger discharge current and larger opening distance of mechanical switches and thus improve the reliability of arc extinguishing.

3. The voltage detection switch is turned on when the mechanical switch is arcing. Because the voltage change rate across the mechanical switch is large and the distance between the contacts of the mechanical switch is extremely small during the breaking of the mechanical switch and before arcing of the mechanical switch, it requires a large capacitance of capacitor to stabilize arc extinguishing in order to achieve the purpose of no-arc breaking. The arc is extinguished completely within 100 microseconds when the voltage detection switch is turned on (if the time is too long, the capacitor needs an extreme large capacitance, and the arc extinguishing stability is poor).

4. During the breaking of the mechanical switch, the voltage detection switch is turned on when the breakdown voltage of the opening distance between the contacts of the mechanical switch is greater than the working voltage of the mechanical switch and the purpose can be achieved by the delay conduction of the voltage detection switch. The delay control of the power semiconductor device can be completed either by the delay circuit of the voltage detection switch (such as the microcontroller of the control unit or the delay circuit of the resistance-capacitance transistor) when the contacts of the mechanical switch are detected to be disconnected by the voltage detection switch; or by the power semiconductor device when the voltage detection switch detects a higher voltage across the mechanical switch (i.e., the voltage detection switch with high opening voltage). This has the advantages of effectively preventing the arc from reigniting when arc extinguishing and requiring minimal capacitance of capacitor. The parameter can be adjusted according to the breaking speed of the mechanical switch, the capacitance of capacitor, the working voltage of the mechanical switch and the characteristics of the load.

In the foregoing embodiments, the capacitance requirement can be reduced by decreasing the inductance and internal resistance of the discharge circuit as much as possible and increasing the rising rate of the discharge current of the capacitor within the range of the current rising rate of the power semiconductor device. The power semiconductor device can adopt unidirectional thyristors greater than 180 A per microsecond (multiple thyristors can be used in parallel), by using the internal resistance of the discharge circuit of capacitor; the operation of the power semiconductor device is in a safe range; and the arc extinguishing speed and the arc extinguishing reliability are improved.

In the foregoing embodiments, the mechanical switch is a contactor (relay). In the present disclosure, any mechanical breakpoint as an arc extinguishing target can also be defined as a mechanical switch, such as a fuse link, a connector, etc.

In summary, the present disclosure has the following advantages:

1. Due to the adoption of the voltage detection switch, the circuit is simple, a large potential difference is formed between the capacitor and the load, and the voltage detection switch is turned on, which is beneficial to overcoming the influence of the internal resistance of the capacitor discharge circuit, improving the instantaneous discharge current of the capacitor, and low capacitance requirements. Due to the small capacitance of capacitor, it has the advantages of low cost, small volume, high reliability, and low power required by the first current limiting element and fast response speed (i.e., fast charging and discharging speed, which is very important for improving the response speed of arc extinguishing of multiplex mechanical switches. When the capacitance of capacitor is designed to be 30 microfarads, the first current limiting element is designed to be 33 ohms for arc extinguishing of mechanical switch loaded with tens of ampere to hundreds of ampere, which can complete the entire arc extinguishing of capacitor charging and discharging in ten milliseconds. According to the technical scheme shown in FIG. 10, the arc extinguishing of tens or even hundreds of mechanical switches can be completed in one second). For a load of 800V and 500 A, only a few tens of microfarads of capacitance can satisfy the rapid arc extinguishing within a few microseconds to several tens of microseconds (not exceeding 100 microseconds).

2. Compared with full-controlled type device, the adopted semi-controlled type device (switch) has the advantages of large overload capacity, short conduction time, low cost, and no breaking overvoltage when the current crosses zero and cut off, which can economically solve the arc extinguishing problem of load above 100 ampere (unidirectional thyristors with rated working current of 25 ampere can be adopted to extinguish arc for current above hundreds ampere).

3. The arc extinguishing mode connected in parallel with the load is more flexible and convenient to use, and the arc extinguishing mode of capacitor discharging can effectively overcome the phenomenon of cutting load overvoltage.

4. When the voltage fluctuates, the voltage detection switch is not conductive and the voltage detection switch has no temperature rise, thus the electrical life of capacitor is long.

5. It has wide application range, and can extinguish arc for manually controlled switches, stroke switches and other mechanical switches without control coils.

6. The breaking voltage (arc breaking voltage) of the mechanical switch is reduced, and the electrical life of the mechanical switch is greatly prolonged (as shown in FIG. 1, when the working voltage across the mechanical switch is 600V and the load current is 300 A, the electrical life is about 150 times. When the mechanical switch is matched with the direct current arc extinguisher of the disclosure and the open value of the voltage detection switch is designed to be 90V, which is equivalent to breaking the direct circuit of 90V/300 A by the mechanical switch, and the electrical life of the mechanical switch can reach more than 20,000 times).

1. A direct current arc extinguishing apparatus, used for arc extinguishing of a mechanical switch which is connected with a load in series, wherein the apparatus comprises a voltage detection switch and a capacitor, the voltage detection switch is connected with the capacitor; during the breaking of the mechanical switch, the capacitor forms a discharge loop by the voltage detection switch and the load and is used for breaking arc extinguishing of the mechanical switch.

2. The direct current arc extinguishing apparatus according to claim 1, wherein the voltage detection switch is turned on in an interval where the potential difference across the mechanical switch is greater than 5V and less than or equal to 20V; or greater than 20V and less than the working voltage of the mechanical switch.

3.-5. (canceled)

6. The direct current arc extinguishing apparatus according to claim 1, wherein the voltage detection switch is a semi-controlled switch.

7. The direct current arc extinguishing apparatus according to claim 6, wherein the voltage detection switch is a two-end circuit.

8. The direct current arc extinguishing apparatus according to claim 7, further comprising a charging unit for charging the capacitor, wherein the charging unit is connected in parallel with the voltage detection switch.

9. The direct current arc extinguishing apparatus according to claim 8, wherein the charging unit comprises either a first diode, or a first current limiting element, or a series connection of the first diode and the first current limiting element.

10. The direct current arc extinguishing apparatus according to claim 6, further comprising a first current limiting element, wherein the capacitor is connected with the power input port of the mechanical switch by the first current limiting element; the voltage detection switch is a three-end circuit; and the detection port of the voltage detection switch is connected with the power input port or the contact bridge of the mechanical switch.

11. The direct current arc extinguishing apparatus according to claim 6, wherein the semi-controlled switch comprises a thyristor, either the gate of the thyristor is connected with the anode of the thyristor, or the gate of the thyristor is connected with the second anode of the thyristor.

12. The direct current arc extinguishing apparatus according to claim 11, further comprising a first semiconductor device, wherein the cut-in voltage of the first semiconductor device is greater than 3V and the gate of the thyristor is connected with either the anode or the second anode by the first semiconductor device.

13. The direct current arc extinguishing apparatus according to claim 12, wherein the first semiconductor device is a Zener diode, a transient voltage suppressor, a trigger diode or a varistor.

14. The direct current arc extinguishing apparatus according to claim 13, further comprising a second diode, wherein the second diode, the first semiconductor device and the gate of the thyristor are connected in series.

15. The direct current arc extinguishing apparatus according to claim 6, wherein the detection port of the voltage detection switch is non-insulated and isolated from the output port of the voltage detection switch.

16. The direct current arc extinguishing apparatus according to claim 6, wherein the voltage detection switch is a delay semiconductor switch.

17. The direct current arc extinguishing apparatus according to claim 6, wherein the insulating material is used for packaging the apparatus into a device.

18. The direct current arc extinguishing apparatus according to claim 6, wherein the apparatus is packaged as a device with a charging unit for charging the capacitor using insulating material.

19. The direct current arc extinguishing apparatus according to claim 1, wherein the voltage detection switch comprises a control unit and a power semiconductor device; a voltage signal of the connection node of the mechanical switch and the load is transmitted to the control unit; the power semiconductor device is connected with the control unit; during the breaking of the mechanical switch, the power semiconductor device is turned on, and the capacitor is discharged by the power semiconductor device and the load.

20. The direct current arc extinguishing apparatus according to claim 19, wherein during the breaking of the mechanical switch, the control unit detects that the contact of the mechanical switch is being broken, and the power semiconductor device is controlled to be turned on by delay, which is greater than 100 microseconds.

21. The direct current arc extinguishing apparatus according to claim 19, wherein the control unit performs A/D acquisition on the voltage signal.

22. The direct current arc extinguishing apparatus according to claim 21, further comprising a charging unit for charging the capacitor, wherein the charging unit is connected in parallel with the power semiconductor device, the connection node of the mechanical switch and the load charges the capacitor by the charging unit, and the voltage signal is the voltage of the load.

23. The direct current arc extinguishing apparatus according to claim 22, wherein the charging unit comprises a first diode and a first current limiting element connected in series, and the voltage signal of the capacitor is transmitted to the control unit for detecting the capacity of the capacitor.

24. The direct current arc extinguishing apparatus according to claim 19, wherein the voltage signal is the voltage of the load, or the voltage relative to the other port of the power semiconductor device, or the voltage relative to the power input of the mechanical switch.

25. (canceled)

26. The direct current arc extinguishing apparatus according to claim 19, wherein either the control signal of the mechanical switch is transmitted to the control unit, or the control signal of the control unit is transmitted to the mechanical switch.

27. The direct current arc extinguishing apparatus according to claim 19, wherein the control unit stores an adaptive control program, and optimizes arc extinguishing control parameter by utilizing changes of the voltage signal.

28. The direct current arc extinguishing apparatus according to claim 19, further comprising a charging unit for charging the capacitor, wherein the charging unit at least comprises a charging switch, and a control signal of the control unit is transmitted to the charging switch.

29. The direct current arc extinguishing apparatus according to claim 28, wherein the main loop power supply of the mechanical switch charges the capacitor by the charging switch.

30.-31. (canceled)

32. The direct current arc extinguishing apparatus according to claim 28, wherein during the closing operation of the mechanical switch, the control unit controls the charging switch and the power semiconductor device to be turned on, and then the mechanical switch is closed; during the breaking operation of the mechanical switch, the charging switch is in a cut-off state.

33. The direct current arc extinguishing apparatus according to claim 28, further comprising a fourth semiconductor switch, wherein the control port of the fourth semiconductor switch is connected with the control unit; the capacitor and the fourth semiconductor switch form a second series circuit; and the capacitor forms a discharge loop by the fourth semiconductor switch, the power semiconductor device and the load.

34. The direct current arc extinguishing apparatus according to claim 33, further comprising a third diode, wherein the main loop power supply of the mechanical switch charges the capacitor by the charging switch and the third diode.

35. The direct current arc extinguishing apparatus according to claim 33, further comprising a fifth semiconductor device, wherein the input power supply end of the mechanical switch is connected with a battery, and the battery is connected with a charging mechanical switch; during the breaking of the charging mechanical switch, the capacitor is discharged by the fourth semiconductor switch and the fifth semiconductor device, and the battery for breaking arc extinguishing of the charging mechanical switch, and the fifth semiconductor device is either a fifth diode, or a fifth unidirectional thyristor connected with the control unit.

36. The direct current arc extinguishing apparatus according to claim 33, wherein voltage signal of common terminal of the second series circuit, the charging switch and the power semiconductor device are connected to the control unit.

37.-40. (canceled)

41. The direct current arc extinguishing apparatus according to claim 28, wherein the control signal of the mechanical switch is transmitted to the control unit, or the control signal of the control unit is transmitted to the mechanical switch.

42. The direct current arc extinguishing apparatus according to claim 28, wherein the control unit controls the power semiconductor device to be turned on when the control unit detects arcing in the off state of the mechanical switch.

43. The direct current arc extinguishing apparatus according to claim 28, further comprising a fifth unidirectional thyristor, wherein the fifth unidirectional thyristor is connected with the control unit; the input power supply end of the mechanical switch is connected with a battery; the battery is connected with a charging mechanical switch; and during the breaking of the charging mechanical switch, the capacitor is discharged by the battery and the fifth unidirectional thyristor, which is used for breaking arc extinguishing of the charging mechanical switch.

44. The direct current arc extinguishing apparatus according to claim 28, wherein the number of mechanical switches is at least two, including a first mechanical switch and a second mechanical switch; the number of the loads is at least two, including a first load and a second load; the number of the power semiconductor devices is at least two, including a first power semiconductor device and a second power semiconductor device.

45.-47. (canceled)

48. The direct current arc extinguishing apparatus according to claim 44, wherein during the breaking of the mechanical switch, the control unit detects that the contact of the mechanical switch is being broken, and controls the power semiconductor device to be turned on with delay, which is greater than 100 microseconds; the control unit stores parameter related to the current of the load or receives parameter related to the current of the load; and during the breaking of the mechanical switch, the larger the current of the load, the longer the delay time.

49.-50. (canceled)

51. The direct current arc extinguishing apparatus according to claim 19, wherein the number of mechanical switches is at least two, including a first mechanical switch and a second mechanical switch; the number of the loads is at least two, including a first load and a second load; the number of the power semiconductor devices is at least two, including a first power semiconductor device and a second power semiconductor device.
